(19) United States
(12) Patent Application Publication
(10) Pub. No.: US 2025/0317660 A1
(43) Pub. Date: Oct. 9, 2025

(54) INFORMATION PROCESSING APPARATUS AND INFORMATION PROCESSING SYSTEM

(71) Applicants: Sony Group Corporation, Tokyo (JP); Sony Semiconductor Solutions Corporation, Kanagawa (JP)

(72) Inventors: Kei Nakagawa, Kanagawa (JP); Atsushi Suzuki, Kanagawa (JP); Youji Sakioka, Tokyo (JP); Yusuke Minagawa, Kanagawa (JP)

(21) Appl. No.: 18/701,071

(22) PCT Filed: Oct. 14, 2022
(86) PCT No.: PCT/JP2022/038353

§ 371 Date: Jun. 20, 2025

(30) Foreign Application Priority Data
Oct. 20, 2021 (JP) 2021-171859

(51) Int. Cl. H04N 25/532; G06T 7/70; H04N 25/77

(52) U.S. Cl. CPC H04N 25/532; G06T 7/70; H04N 25/77

(57) ABSTRACT

Switching is performed between a global shutter method and a local shutter method. A pixel control unit 30 performs local shutter and global shutter on a pixel 100. The image generation unit 40 generates a first frame, which is an image based on the first image signal, and a second frame, which is an image based on the second image signal. The object detection unit 50 detects a target object from the second frame. The distance measurement unit 60 measures a distance to the target object based on the first frame generated based on reflected light obtained by allowing the emitted light emitted to the target object to be reflected by the target object.

### FIELD

The present disclosure relates to an information processing apparatus and an information processing system.

### BACKGROUND

An information processing apparatus including an imaging element that generates an image of a subject is used. This information processing apparatus is an apparatus that processes the image generated by the imaging element. The imaging element used in the information processing apparatus is configured by arranging pixels, each of which has a photoelectric conversion element, in a two-dimensional matrix. Furthermore, this imaging element repeats exposure for performing photoelectric conversion of light from the subject and reading of an image signal based on a charge generated by the photoelectric conversion from each of the pixels, thereby outputting a generated image.

In this pixel, the charge generated by the photoelectric conversion during the exposure period is accumulated inside the photoelectric conversion element. Then, the charge accumulated in the photoelectric conversion element after the lapse of the exposure period is transferred to a charge storage unit. The charge storage unit can be configured by a floating diffusion layer formed by a diffusion region disposed on a semiconductor substrate having the photoelectric conversion element formed thereon. An amplification transistor is connected to the floating diffusion layer, and a signal corresponding to the charge stored in the floating diffusion layer is generated. Such a signal generation method is referred to as a floating diffusion amplifier. It is noted that the floating diffusion layer is reset by a reset unit configured to discharge the charge remaining immediately before the transfer of the charge.

Meanwhile, reading is sequentially performed for each row of the pixels arranged in the two-dimensional matrix. At this time, reading is simultaneously performed in the pixels arranged in one row. As a method of generating such an image, a rolling shutter method and a global shutter method are used.

The rolling shutter method is a method of sequentially performing exposure and reading with a period shifted for each row, and is a method capable of simplifying a configuration of the imaging element. However, since a timing of exposure differs for each row in the rolling shutter method, there is a problem in that distortion occurs in an image when the image of a moving subject is captured.

The global shutter method is a method in which exposure is simultaneously performed in all the pixels and charges generated during the exposure period are stored. The reading is sequentially performed for each row based on the stored charges. Image distortion can be prevented by a global shutter that simultaneously exposes all the pixels. Since it takes time from the end of the exposure period to the reading, the charge is transferred to a second charge storage unit different from the above-described floating diffusion layer, and a signal is generated based on the charge of the second charge storage unit at the time of reading. Since the floating diffusion layer is adjacent to the photoelectric conversion element, there is a problem in that the charge due to leaking incident light is superimposed on the charge of the floating diffusion layer. In order to prevent this deterioration in image quality, the second charge storage unit is required.

In the imaging element adopting the global shutter method, an imaging element in which a capacitive element is applied to the second charge storage unit has been proposed. For example, an imaging element using two capacitive elements as the second charge storage unit has been proposed (refer to, for example, Patent Literature 1).

### CITATION LIST

### Patent Literature

Patent Literature 1: US 2020/279876 A

### SUMMARY

### Technical Problem

However, in the above-described conventional technique, there is a problem in that the global shutter method and the local shutter method cannot be switched.

Therefore, the present disclosure proposes an information processing apparatus and an information processing system that perform imaging by switching between a global shutter method and a local shutter method.

### Solution to Problem

An information processing apparatus according to the present disclosure includes: a pixel array unit having pixels arranged therein in a two-dimensional matrix, the pixel including a light receiving unit configured to expose incident light and to output a voltage level corresponding to an exposure amount, a signal level storage unit configured to store the voltage level output from the light receiving unit, a first image signal generation unit configured to generate a first image signal, which is a signal corresponding to the voltage level stored in the signal level storage unit, and a second image signal generation unit configured to generate a second image signal, which is a signal corresponding to the voltage level output from the light receiving unit; a pixel control unit configured to perform a local shutter and a global shutter, wherein the local shutter sequentially performs, on the pixels, exposure of the incident light in the light receiving unit and generation of the second image signal in the second image signal generation unit based on the voltage level output after the exposure at a timing shifted for each row of the pixel array unit, and the global shutter simultaneously performs, on the pixels arranged in the pixel array unit, the exposure of the incident light in the light receiving unit and storage of the voltage level output after the exposure in the signal level storage unit, and sequentially performs generation of the first image signal in the first image signal generation unit at the timing shifted for each row of the pixel array unit; an image generation unit configured to generate a first frame, which is an image based on the first image signal, and a second frame, which is an image based on the second image signal; an object detection unit configured to detect a target object from the second frame; a distance measurement unit configured to measure a distance to the target object based on the first frame generated based on reflected light obtained by allowing emitted light emitted to the target object to be reflected by the target object; and a control unit configured to perform second frame generation control of causing the pixel control unit to control the local shutter and causing the image generation unit to generate the second frame, target object detection control of causing the object detection unit to detect the target object, first frame generation control of causing the pixel control unit to control the global shutter and causing the image generation unit to generate the first frame, and distance measurement control of causing the distance measurement unit to measure the distance to the target object.

### BRIEF DESCRIPTION OF DRAWINGS

FIG. 1 is a diagram illustrating an overall configuration example of an information processing apparatus according to an embodiment of the present disclosure. 15

FIG. 2 is a diagram illustrating a configuration example of the information processing apparatus according to the embodiment of the present disclosure.

FIG. 3 is a diagram illustrating a configuration example of a pixel according to the embodiment of the present disclosure.

FIG. 4 is a diagram illustrating an example of generation of an image signal according to the embodiment of the present disclosure.

FIG. 5 is a diagram illustrating an example of generation of a frame according to the embodiment of the present disclosure.

FIG. 6 is a diagram illustrating the example of the generation of the image signal according to the embodiment of the present disclosure.

FIG. 7 is a diagram illustrating the example of the generation of the frame according to the embodiment of the present disclosure.

FIG. 8A is a diagram illustrating an example of a distance measurement method according to the embodiment of the present disclosure.

FIG. 8B is a diagram illustrating the example of the distance measurement method according to the embodiment of the present disclosure.

FIG. 9 is a diagram illustrating an example of a processing method according to the embodiment of the present disclosure.

FIG. 10 is a diagram illustrating another example of the processing method according to the embodiment of the present disclosure.

FIG. 11 is a diagram illustrating a configuration example of a pixel according to a modification of the embodiment of the present disclosure.

FIG. 12 is a diagram illustrating another configuration example of the pixel according to the modification of the embodiment of the present disclosure.

### DESCRIPTION OF EMBODIMENTS

Hereinafter, embodiments of the present disclosure will be described in detail with reference to the drawings. The description will be given in the following order. In each of the following embodiments, the same parts are denoted by the same reference numerals, and redundant description will be omitted.
1. Embodiment
2. Modification

### 1. Embodiment

### [Overall Configuration of Information Processing Apparatus]

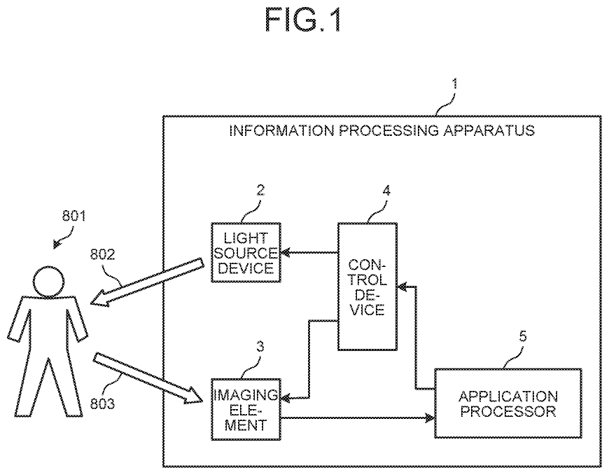

FIG. 1 is a diagram illustrating an overall configuration example of an information processing apparatus according to an embodiment of the present disclosure. The drawing is a diagram illustrating a configuration example of an information processing apparatus 1. The information processing apparatus 1 is an apparatus that generates image data of a target object among subjects and processes the image of the target object. The information processing apparatus 1 includes a light source device 2, an imaging element 3, a control device 4, and an application processor 5.

The light source device 2 emits emitted light to a subject or the like. The drawing illustrates an example in which emitted light 802 is emitted to a subject 801. The emitted light 802 is reflected by the subject 801, and reflected light 803 is incident on the imaging element 3 which will be described later. It is noted that the light source device 2 is an example of a light source unit described in the claims.

The imaging element 3 captures an image of a subject or the like to generate an image. Furthermore, the imaging element 3 receives the reflected light 803 in the drawing. A distance to the subject 801 can be measured based on the received reflected light 803.

The control device 4 controls a hardware unit such as the light source device 2 and the imaging element 3. The control device 4 controls emission of the emitted light 802 in the light source device 2, and controls imaging of an image of a subject in the imaging element 3 and generation of an image based on the reflected light 803.

The application processor 5 controls the entire information processing apparatus 1. In addition, the application processor 5 performs software control and processing in the information processing apparatus 1.

The information processing apparatus 1 in the drawing detects a target object from the image of the subject generated by the imaging element 3. The target object is an object to be processed by the information processing apparatus 1 and corresponds to, for example, a person. After detecting the target object, the information processing apparatus 1 measures a distance to the target object. Furthermore, the information processing apparatus 1 acquires a three-dimensional shape of the target object by measuring the distance. The three-dimensional shape of the target object can be represented by, for example, a depth map representing the surface shape of the target object. The application processor 5 performs processing such as detection of the target object and measurement of the distance to the target object. Furthermore, the application processor 5 can also perform processing of authenticating a person or the like based on the three-dimensional shape of the target object.

### [Configuration of Information Processing Apparatus]

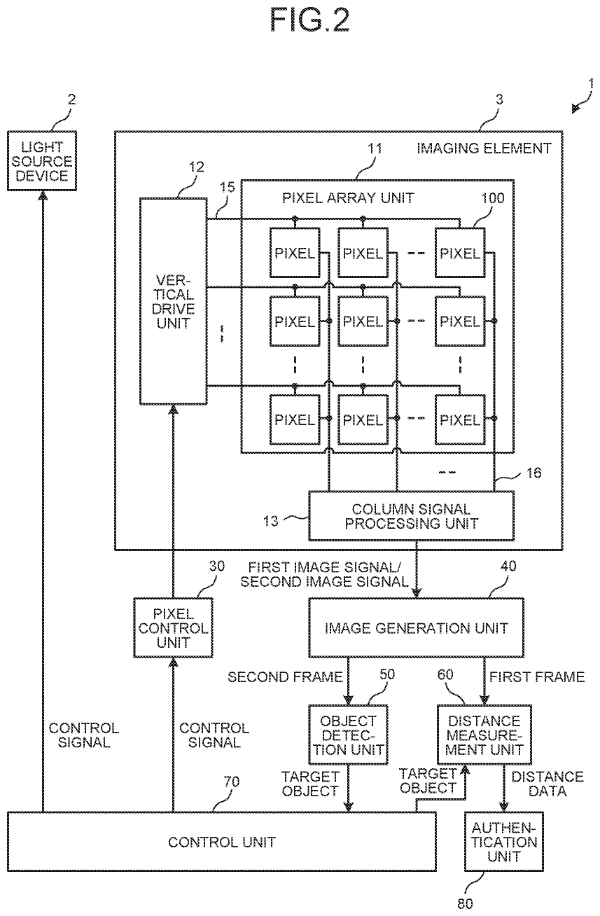

FIG. 2 is a diagram illustrating a configuration example of the information processing apparatus according to the embodiment of the present disclosure. The drawing is a block diagram illustrating a configuration example of the information processing apparatus 1, and is a diagram illustrating blocks representing processing by the application processor 5 and the like described above. The information processing apparatus 1 includes the light source device 2, the imaging element 3, a pixel control unit 30, an image generation unit 40, an object detection unit 50, a distance measurement unit 60, an authentication unit 80, and a control unit 70. It is noted that the information processing apparatus 1 is an example of an information processing system described in the claims.

The imaging element 3 captures an image of a subject to generate and output an image signal. The imaging element 3 in the drawing includes a pixel array unit 11, a vertical drive unit 12, and a column signal processing unit 13.

The pixel array unit 11 is configured by arranging a plurality of pixels 100 in a two-dimensional matrix. Each of the pixels 100 includes a photoelectric conversion unit that performs photoelectric conversion of incident light, and generates an image signal of a subject based on the emitted incident light. For example, a photodiode can be used as the photoelectric conversion unit. Signal lines 15 and 16 are wired to each of the pixels 100. The pixel 100 is controlled by a control signal transmitted from the signal line 15 to generate an image signal, and outputs the generated image signal via the signal line 16. It is noted that the signal line 15 is arranged for each row of the shape of the two-dimensional matrix, and is commonly wired to the plurality of pixels 100 arranged in one row. The signal line 16 is arranged for each column of the shape of the two-dimensional matrix, and is commonly wired to the plurality of pixels 100 arranged in one column.

The vertical drive unit 12 generates the control signal of the pixel 100 described above. The vertical drive unit 12 in the drawing generates the control signal for each row of the two-dimensional matrix of the pixel array unit 11, and sequentially outputs the control signal via the signal line 15.

The column signal processing unit 13 processes the image signal generated by the pixel 100. The column signal processing unit 13 in the drawing simultaneously processes the image signals from the plurality of pixels 100 arranged in one row of the pixel array unit 11, in which the image signals are transmitted via the signal line 16. As this processing, for example, analog-to-digital conversion for converting an analog image signal generated by the pixel 100 into a digital image signal and correlated double sampling (CDS) for removing an offset error of the image signal can be performed. The processed image signal is output to a circuit or the like outside the imaging element 3.

As described later, the pixel 100 outputs a first image signal and a second image signal. The first image signal is an image signal generated by the above-described global shutter method. In addition, the second image signal is an image signal generated by the local shutter method described above. In this manner, the pixel 100 in the drawing can generate the image signal by performing switching between the global shutter method and the local shutter method. The vertical drive unit 12 in the drawing generates a control signal corresponding to each of the global shutter method and the local shutter method, and outputs the control signal to the pixel 100.

In addition, the column signal processing unit 13 performs the above-described processing on each of the first image signal and the second image signal. It is noted that the column signal processing unit 13 is an example of an image signal processing unit described in the claims.

As described above, the light source device 2 emits emitted light for distance measurement. The light source device 2 includes a light emitting element such as a laser diode and a drive unit for the light emitting element. The drive unit drives the light emitting element based on a control signal output from the control unit 70 described later. The light source device 2 can emit, for example, pattern light in which a plurality of dotted bright portions are arranged. In this case, the imaging element 3 in the drawing measures the distance to the subject based on the pattern light reflected by the subject. Details of the distance measurement will be described later. It is noted that the light source device 2 is an example of a light source unit described in the claims.

The pixel control unit 30 controls imaging of the pixel 100. The pixel control unit 30 performs a control operation of switching between the local shutter method and the global shutter method in the pixel 100. Details of the local shutter method and the global shutter method will be described later. The pixel control unit 30 in the drawing performs switching between the local shutter method and the global shutter method of the pixel 100 by controlling the vertical drive unit 12.

The image generation unit 40 generates a frame, which is an image for one screen based on the image signal output from the imaging element 3 (the column signal processing unit 13). The image generation unit 40 generates a first frame based on the first image signal and a second frame based on the second image signal. The generated first frame is output to the distance measurement unit 60, and the generated second frame is output to the object detection unit 50.

The object detection unit 50 detects a target object such as a person from the second frame. The target object can be detected, for example, by comparison with an image of a person registered in advance. The object detection unit 50 outputs the detected target object to the control unit 70.

The distance measurement unit 60 measures the distance to the target object. The distance measurement unit 60 measures the distance to the target object based on the first frame generated based on the reflected light obtained by allowing the emitted light emitted to the target object to be reflected by the target object. The distance measurement unit 60 can generate the above-described depth map based on the measured distance. It is noted that, as the target object, for example, the target object transmitted via the control unit 70 can be applied. Distance data such as the depth map is output to the authentication unit 80.

The control unit 70 controls the entire information processing apparatus 1. The control unit 70 can perform second frame generation control of causing the pixel control unit 30 to control a local shutter and causing the image generation unit 40 to generate the second frame, target object detection control of causing the object detection unit 50 to detect the target object, first frame generation control of causing the pixel control unit 30 to control a global shutter and causing the image generation unit 40 to generate the first frame, and distance measurement control of causing the distance measurement unit 60 to measure the distance to the target object. Furthermore, the control unit 70 can further perform light source control of causing the light source device to emit the emitted light.

The authentication unit 80 authenticates the target object based on the distance data output from the distance measurement unit 60. The authentication unit 80 can output a result of the authentication to an external device.

It is noted that the configuration of the information processing apparatus 1 is not limited to this example. For example, it is also possible to adopt a configuration in which the light source device 2 is omitted. In this case, the control signal generated by the control unit 70 is output to the light source device 2 arranged outside the information processing apparatus 1.

### [Configuration of Pixel]

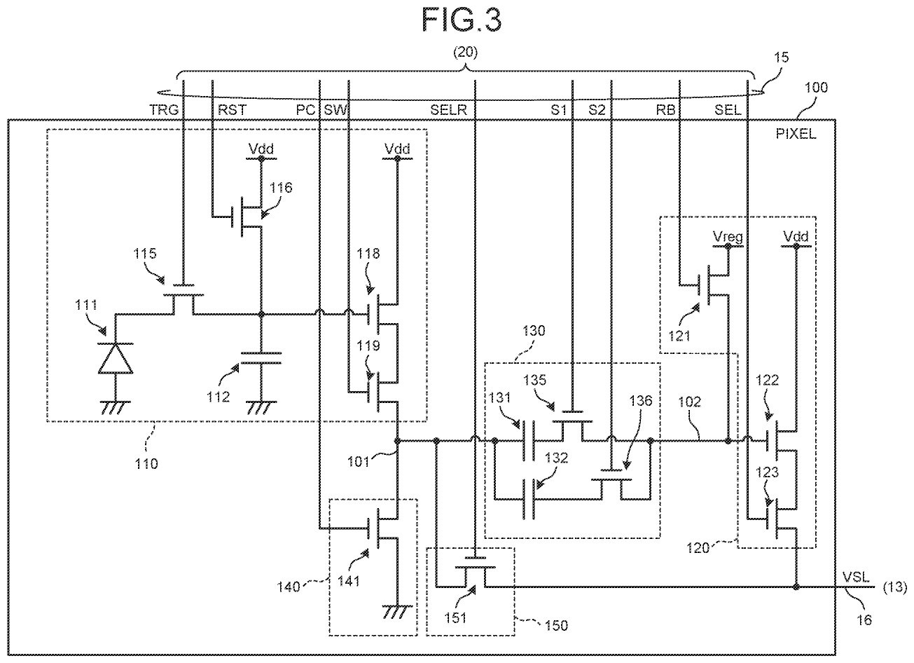

FIG. 3 is a diagram illustrating a configuration example of a pixel according to the embodiment of the present disclosure. The drawing is a circuit diagram illustrating the configuration example of the pixel 100. The pixel 100 in the drawing includes a light receiving unit 110, a signal level storage unit 130, a first image signal generation unit 120, a constant current circuit 140, and a second image signal generation unit 150. Furthermore, a signal line TRG, a signal line RST, a signal line PC, a signal line SW, a signal line SELR, a signal line S1, a signal line S2, a signal line RB, a signal line SEL, and a signal line VSL are wired to the pixel 100. The signal line TRG, the signal line RST, the signal line PC, the signal line SW, the signal line SELR, the signal line S1, the signal line S2, the signal line RB, and the signal line SEL constitute the signal line 15. The signal line VSL constitutes the signal line 16.

The light receiving unit 110 exposes incident light and outputs a voltage level corresponding to the exposure amount. The light receiving unit 110 in the drawing includes a photoelectric conversion unit 111, a charge storage unit 112, a charge transfer unit 115, a first reset unit 116, a first amplification unit 118, and a first selection unit 119. It is noted that an n-channel MOS transistor can be used for the charge storage unit 112, the charge transfer unit 115, the first reset unit 116, the first amplification unit 118, and the first selection unit 119.

The anode of the photoelectric conversion unit 111 is grounded, and the cathode thereof is connected to the source of the charge transfer unit 115. The drain of the charge transfer unit 115 is connected to the source of the first reset unit 116, the gate of the first amplification unit 118, and one end of the charge storage unit 112. The other end of the charge storage unit 112 is grounded. The drain of the first reset unit 116 is connected to a power supply line Vdd. The drain of the first amplification unit 118 is connected to the power supply line Vdd, and the source thereof is connected to the drain of the first selection unit 119. The source of the first selection unit 119 is connected to a first output node 101. The signal line TRG, the signal line RST, and the signal line SW are connected to the gate of the charge transfer unit 115, the gate of the first reset unit 116, and the gate of the first selection unit 119, respectively.

The photoelectric conversion unit 111 performs photoelectric conversion of incident light. The photoelectric conversion unit 111 can include a photodiode formed on a semiconductor substrate.

The charge transfer unit 115 transfers the charge of the photoelectric conversion unit 111 to the charge storage unit 112. The charge transfer unit 115 transfers the charge by electrically connecting the photoelectric conversion unit 111 to the charge storage unit 112.

The charge storage unit 112 stores the charge generated by the photoelectric conversion of the photoelectric conversion unit 111. The above-described floating diffusion layer can be used for the charge storage unit 112.

The first reset unit 116 resets the charge storage unit 112. The first reset unit 116 performs reset by discharging the charge of the charge storage unit 112 to the power supply line Vdd.

The first amplification unit 118 generates a signal corresponding to the charge stored in the charge storage unit 112. The first amplification unit 118 constitutes a source follower circuit together with the constant current circuit 140 connected via the first output node 101, and outputs the generated signal to the first output node 101. It is noted that, in the pixel 100 in the drawing, a voltage level of the signal generated by the first amplification unit 118 is transmitted to the signal level storage unit 130 and the second image signal generation unit 150 via the first output node 101. In addition, the first amplification unit 118 outputs, to the first output node 101, a reset level, which is a voltage level after being reset by the first reset unit 116, and a signal level, which is a voltage level when the charge generated by the photoelectric conversion unit 111 during the exposure period is stored in the charge storage unit 112.

The first selection unit 119 outputs the signal generated by the first amplification unit 118 to the first output node 101. The first selection unit 119 is connected between the first amplification unit 118 and the first output node 101, and transmits the signal of the first amplification unit 118 to the first output node 101 by conducting itself. By arranging the first selection unit 119 to be in the non-conduction state, it is possible to reduce leakage current when the first amplification unit 118 is in the off state.

The constant current circuit 140 is a constant current circuit constituting a load of the first amplification unit 118 described above. The constant current circuit 140 supplies a constant current suction current (sink current) to the first output node 101. The constant current circuit 105 in the drawing includes a MOS transistor 141.

The drain of the MOS transistor 141 is connected to the first output node 101, and the source thereof is grounded. The gate of the gate of the MOS transistor 141 is connected to the signal line PC.

The signal line PC transmits a bias voltage. The bias voltage from the signal line PC is applied to the gate of the MOS transistor 141, and the MOS transistor 141 supplies a constant current corresponding to the applied bias voltage.

The signal level storage unit 130 stores the voltage level output from the light receiving unit. The signal level storage unit 130 is connected to the first output node 101 and stores the level of the signal output from the light receiving unit 110. The signal level storage unit 130 in the drawing includes a first capacitive element 131, a second capacitive element 132, a first switch element 135, and a second switch element 136.

One end of the first capacitive element 131 and one end of the second capacitive element 132 are commonly connected to the first output node 101. The other end of the first capacitive element 131 and the other end of the second capacitive element 132 are connected to the source of the first switch element 135 and the source of the second switch element 136, respectively. The drain of the first switch element 135 and the drain of the second switch element 136 are commonly connected to a second output node 102. The gate of the first switch element 135 and the gate of the second switch element 136 are connected to the signal line S1 and the signal line S2, respectively.

The first capacitive element 131 is a capacitive element that stores the reset level.

The second capacitive element 132 is a capacitive element that stores the signal level.

The first switch element 135 is an element that controls a current flowing through the first capacitive element 131. The first switch element 135 is connected between the first capacitive element 131 and the second output node 102.

The second switch element 136 is an element that controls a current flowing through the second capacitive element 132. The second switch element 136 is connected between the second capacitive element 132 and the second output node 102.

The first image signal generation unit 120 generates the first image signal, which is a signal corresponding to the voltage level stored in the capacitive element unit. The first image signal generation unit 120 in the drawing generates and outputs an image signal corresponding to the signal level stored in the first capacitive element 131 and the second capacitive element 132. The first image signal generation unit 120 in the drawing includes a second reset unit 121, a second amplification unit 122, and a second selection unit 123.

The source of the second reset unit 121 and the gate of the second amplification unit 122 are commonly connected to the second output node 102. The drain of the second reset unit 121 is connected to a power supply line Vreg. The drain of the second amplification unit 122 is connected to the power supply line Vdd, and the source thereof is connected to the drain of the second selection unit 123. The source of the second selection unit 123 is connected to the signal line VSL.

The second reset unit 121 resets the second output node 102. The second reset unit 121 performs reset by applying the voltage of the power supply line Vreg to the second output node 102.

The second amplification unit 122 is an element that generates a signal corresponding to the voltage of the second output node 102. The second amplification unit 122 reads the reset level stored in the first capacitive element 131 and the signal level stored in the second capacitive element 132, and generates the first image signals respectively corresponding to the reset level and the signal level.

The second selection unit 123 is an element that outputs the first image signal generated by the second amplification unit 122 to the signal line VSL. The second selection unit 123 is connected between the second amplification unit 122 and the signal line VSL, and transmits the signal of the second amplification unit 122 to the signal line VSL by conducting itself. It is noted that the circuits of the second amplification unit 122 and the second selection unit 123 constitute a read circuit.

The second image signal generation unit 150 generates the second image signal, which is a signal corresponding to the voltage level output from the light receiving unit 110. The second image signal generation unit 150 in the drawing includes a MOS transistor 151. The drain of the MOS transistor 151 is connected to the first output node 101, and the source thereof is connected to the signal line VSL. The gate of the MOS transistor 151 is connected to the signal line SELR. The MOS transistor 151 itself is conductive so as to output the signal level of the first output node 101 to the signal line VSL. That is, the second image signal generation unit 150 transmits the voltage level of the first output node 101 to the signal line VSL without passing through the signal level storage unit 130. It is noted that the second image signal generation unit 150 outputs the second image signals respectively corresponding to the reset level and the signal level.

The signal level storage unit 130 and the first image signal generation unit 120 can be used at the time of imaging by the global shutter method. Furthermore, the second image signal generation unit 150 can be used at the time of imaging by the local shutter method.

### [Generation of Image Signal of Local Shutter Method]

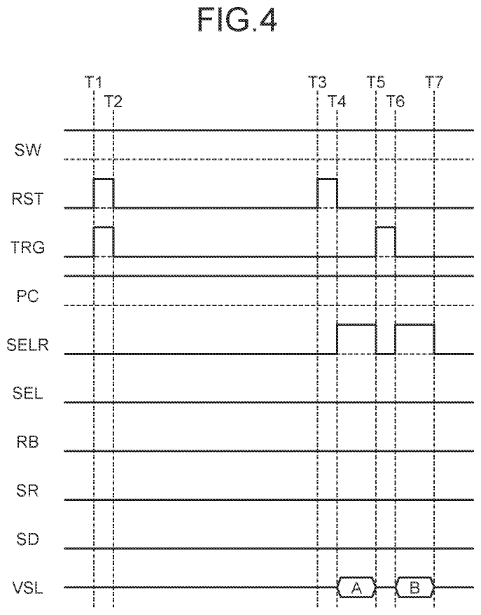

FIG. 4 is a diagram illustrating an example of generation of the image signal according to the embodiment of the present disclosure. The drawing is a timing chart illustrating an example of generation of the second image signal to which the local shutter method is applied. “SW”, “RST”, “TRG”, “SELR”, and “SEL” in the drawing respectively represent waveforms of the signal line SW, the signal line RST, the signal line TRG, the signal line SELR, and the signal line SEL. Further, “RB”, “S1”, and “S2” represent waveforms of the signal line RB, the signal line S1, and the signal line S2, respectively. These waveforms are obtained by binarizing the control signals transmitted by the respective signal lines. A portion of a waveform value of “1” represents an ON signal. Here, the ON signal is a signal that brings an MOS transistor, the gate of which receives the control signal, into a conduction state. In addition, “PC” in the drawing represents a bias voltage applied to the signal line PC. Further, “VSL” in the drawing represents an image signal output to the signal line VSL. It is noted that a broken line in the drawing represents a level of 0 V.

In the initial state, the signal line RST, the signal line TRG, and the signal line SELR have a value of “0”. It is noted that the signal line SW has a constant value of “1”, and each of the signal line SEL, the signal line RB, the signal line S1, and the signal line S2 has a constant value of “0”. In addition, a predetermined bias voltage is always applied to the signal line PC.

At T1, the ON signal is applied to the signal line RST, and the first reset unit 116 is conducted. In addition, the ON signal is applied to the signal line TRG, and the charge transfer unit 115 is conducted. As a result, the photoelectric conversion unit 111 and the charge storage unit 112 are reset.

At T2, the application of the ON signals of the signal line RST and the signal line TRG is stopped, and the first reset unit 116 and the charge transfer unit 115 are brought into the non-conduction state. As a result, charge accumulation in the photoelectric conversion unit 111 is started. It is noted that the period from T1 to T2 corresponds to a reset period.

At T3, the ON signal is applied to the signal line RST, the first reset unit 116 is conducted, and the charge storage unit 112 is reset.

At T4, the application of the ON signal of the signal line RST is stopped, and the first reset unit 116 enters the non-conduction state. At this time, the reset level is output to the first output node 101. In addition, the ON signal is applied to the signal line SELR, and the MOS transistor 151 enters the conduction state. As a result, the second image signal at the reset level is output to the signal line VSL. “A” in the drawing represents the second image signal at the reset level.

At T5, the application of the ON signal of the signal line SELR is stopped, and the MOS transistor 151 enters the non-conduction state. In addition, the ON signal is applied to the signal line TRG, and the charge transfer unit 115 is conducted. As a result, the charge accumulated in the photoelectric conversion unit 111 is transferred to the charge storage unit 112. It is noted that the period from T2 to T5 corresponds to an exposure period.

At T6, the application of the ON signal of the signal line TRG is stopped, and the charge transfer unit 115 enters the non-conduction state. At this time, the signal level is output to the first output node 101. In addition, the ON signal is applied to the signal line SELR to bring the MOS transistor 151 into the conduction state, and the second image signal at the signal level is output to the signal line VSL. “B” in the drawing represents the second image signal at the signal level.

At T7, the application of the ON signal of the signal line SELR is stopped. It is noted that the period from T4 to T7 corresponds to a read period during which the image signal is output from the pixel 100. In the generation of the image signal in the drawing, a part of the exposure period overlaps with the read period. It is noted that CDS for subtracting the second image signal at the reset level output in the period from T4 to T5 from the second image signal at the signal level output in the period from T6 to T7 is performed by the column signal processing unit 13. As a result, the influence of an offset error of the second image signal can be reduced.

### [Formation of Frame in Local Shutter Method]

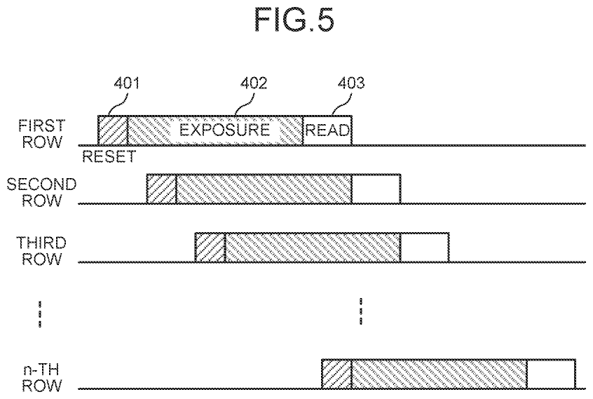

FIG. 5 is a diagram illustrating an example of generation of the frame according to the embodiment of the present disclosure. The drawing is a timing chart illustrating an example of generation of the second frame to which the local shutter method is applied. The drawing illustrates a procedure of generating the second image signal for each row in the pixel array unit 11. “Reset”, “exposure”, and “read” in the drawing represent a reset period 401, an exposure period 402, and a read period 403, respectively. By sequentially performing these processes, the second image signal is read from the pixel 100 for each row. The reset period 401, the exposure period 402, and the read period 403 are performed at a timing shifted for each row. The reason for this is that it is necessary to shift the timing of the read period 403 for each row because the signal line VSL is commonly wired to the pixels 100 arranged in the column of the pixel array unit 11.

The second frame can be formed by generating these second image signals in all the rows of the pixel array unit 11 to generate the second image signals. It is noted that, in imaging of the local shutter method illustrated in the drawing, image distortion occurs in imaging of a moving subject. This is because an exposure timing differs for each row. Meanwhile, as illustrated in FIG. 4, since imaging of the local shutter method can generate the image signal by simple control, it is possible to generate a high-speed frame. Therefore, a frame frequency can be improved. Power consumption can also be reduced.

### [Generation of Image Signal of Global Shutter Method]

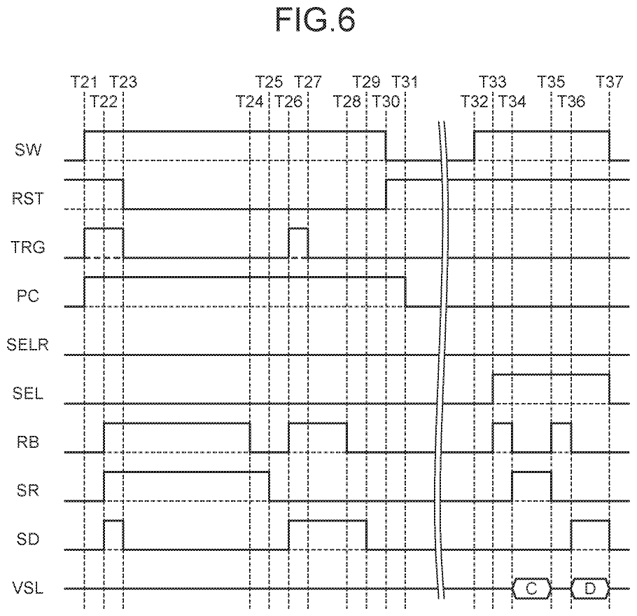

FIG. 6 is a diagram illustrating an example of generation of the image signal according to the embodiment of the present disclosure. The drawing is a timing chart illustrating an example of generation of the second image signal to which the global shutter method is applied. The same notation as in FIG. 4 is used in the drawing.

In the initial state, each of the signal line SW, the signal line TRG, the signal line PC, the signal line SEL, the signal line RB, the signal line S1, and the signal line S2 has a value of “0”. In addition, the signal line RST has a value of “1”. It is noted that the signal line SELR has a constant value of “0”.

At T21, the ON signal is applied to the signal line SW, and the first selection unit 119 enters the conduction state. In addition, the ON signal is applied to the signal line TRG, and the charge transfer unit 115 enters the conduction state. In addition, a predetermined bias voltage is applied to the signal line PC, and the MOS transistor 109 supplies a constant current to the first output node 101. Since the first reset unit 116 and the charge transfer unit 115 are brought into the conduction state, the photoelectric conversion unit 111 and the charge storage unit 112 are reset.

At T22, the ON signal is applied to the signal line RB, and the second reset unit 121 enters the conduction state. In addition, the ON signal is applied to the signal line S1, and the first switch element 135 enters the conduction state. In addition, the ON signal is applied to the signal line S2, and the second switch element 136 is brought into the conduction state. During the period from T1 to T2, the charge storage unit 112 is reset, and the first capacitive element 131 and the second capacitive element 132 are also reset. In addition, the second output node 102 becomes VREG that is the voltage of the power supply line Vreg.

At T23, the application of the ON signal of the signal line RST is stopped, and the first reset unit 116 enters the non-conduction state. Furthermore, the application of the ON signal to the signal line TRG is stopped, and the charge transfer unit 115 enters the non-conduction state. In addition, the application of the ON signal of the signal line S2 is stopped, and the second switch element 136 enters the non-conduction state. As a result, reset of the photoelectric conversion unit 111 and the charge storage unit 112 ends. This reset corresponds to global reset that is simultaneously executed in all the pixels 100. With the end of the reset, the exposure period is started, and the charge generated by the photoelectric conversion is accumulated in the photoelectric conversion unit 111. The reset level is output to the first output node 101. Therefore, the first capacitive element 131 is charged to the reset level.

At T24, the application of the ON signal to the signal line RB is stopped, and the second reset unit 121 enters the non-conduction state. As a result, the reset level is stored in the first capacitive element 131.

At T25, the application of the ON signal to the signal line S1 is stopped, and the first switch element 135 enters the non-conduction state.

At T26, the ON signal is applied to the signal line TRG, and the charge transfer unit 115 enters the conduction state. As a result, the charge of the photoelectric conversion unit 111 is transferred to the charge storage unit 112. In addition, the ON signal is applied to the signal line RB, and the second reset unit 121 enters the conduction state. As a result, the second output node 102 becomes VREG. In addition, the ON signal is applied to the signal line S2, and the second switch element 136 is brought into the conduction state.

At T27, the application of the ON signal to the signal line TRG is stopped, and the charge transfer unit 115 enters the non-conduction state. The signal level is output to the first output node 101. Therefore, the second capacitive element 132 is charged to the signal level.

At T28, the application of the ON signal to the signal line RB is stopped, and the second reset unit 121 enters the non-conduction state. As a result, the image signal level is stored in the second capacitive element 132.

At T29, the application of the ON signal to the signal line S2 is stopped, and the second switch element 136 enters the non-conduction state.

At T30, the application of the ON signal to the signal line SW is stopped, and the first selection unit 119 enters the non-conduction state. In addition, the ON signal is applied to the signal line RST, and the first reset unit 116 enters the conduction state.

At T31, the application of the bias voltage to the signal line PC is stopped. This brings the MOS transistor 109 into the non-conduction state.

At T32, the ON signal is applied to the signal line SW, and the first selection unit 119 enters the conduction state.

At T33, the ON signal is applied to the signal line SEL, and the second selection unit 123 enters the conduction state. In addition, the ON signal is applied to the signal line RB, and the second reset unit 121 enters the conduction state. As a result, the second output node 102 is reset to the voltage of VREG.

At T34, the application of the ON signal to the signal line RB is stopped, and the second reset unit 121 enters the non-conduction state. In addition, the ON signal is applied to the signal line S1, and the first switch element 135 enters the conduction state. Since the first reset unit 116 is in the conduction state, the second output node 102 becomes a voltage in which the reset level is superimposed on VREG. The image signal corresponding to this voltage is generated by the second amplification unit 122 and is output to the signal line VSL. This image signal corresponds to the first image signal at the reset level. “C” in the drawing represents the first image signal at the reset level.

At T35, the application of the ON signal to the signal line S1 is stopped, and the first switch element 135 enters the non-conduction state. In addition, the ON signal is applied to the signal line RB, and the second reset unit 121 enters the conduction state. As a result, the second output node 102 is reset to the voltage of VREG. At T36, the application of the ON signal to the signal line RB is stopped, and the second reset unit 121 enters the non-conduction state. In addition, the ON signal is applied to the signal line S2, and the second switch element 136 is brought into the conduction state. The second output node 102 becomes a voltage in which the signal level is superimposed on VREG. The image signal corresponding to this voltage is generated by the second amplification unit 122 and is output to the signal line VSL as the image signal. This image signal corresponds to the first image signal at the signal level. “D” in the drawing represents the first image signal at the signal level.

At T37, the application of the ON signal to the signal line SW is stopped, and the first selection unit 119 enters the non-conduction state. Furthermore, the application of the ON signal to the signal line SEL is stopped, and the second selection unit 123 enters the non-conduction state. In addition, the application of the ON signal to the signal line S2 is stopped, and the second switch element 136 enters the non-conduction state.

The procedures from T21 to T31 are sequentially executed for all the rows of the pixel array unit 11. As a result, the image signal for one screen can be generated. Further, the period from T32 to T37 corresponds to a read period. It is noted that CDS for subtracting the first image signal at the reset level output in the period from T34 to T35 from the first image signal at the signal level output in the period from T36 to T37 is performed by the column signal processing unit 13. As a result, the VREG component is removed. In addition, the influence of an offset error of the first image signal can be reduced. The offset error corresponds to, for example, an error due to a charge generated by incident light leaking from the vicinity of the photoelectric conversion unit 111. By the above-described subtraction processing, an error due to an offset commonly generated in the first capacitive element 131 and the second capacitive element 132 is reduced, thereby making it possible to reduce parasitic light sensitivity (PLS), which is sensitivity based on leaked incident light.

### [Formation of Frame in Global Shutter Method]

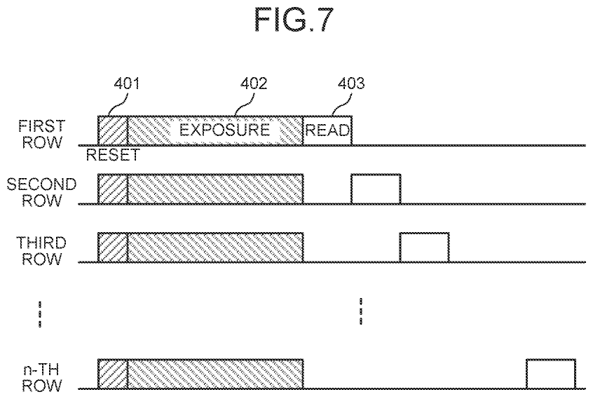

FIG. 7 is a diagram illustrating an example of generation of the frame according to the embodiment of the present disclosure. The drawing is a timing chart illustrating an example of generation of the first frame to which the global shutter method is applied. Similarly to FIG. 5, this drawing illustrates a generation procedure of the second image signal for each row in the pixel array unit 11. In the drawing, the same notation as in FIG. 5 is used.

As illustrated in the drawing, in the global shutter method, reset and exposure are simultaneously performed in all the pixels 100 of the pixel array unit 11. Thereafter, the first frame can be formed by sequentially performing reading for each row to generate the first image signal.

As described above, in the imaging of the global shutter method in which the exposure is simultaneously performed in all the pixels 100, it is possible to prevent occurrence of distortion as in the imaging of the local shutter method. Meanwhile, in the global shutter method, an imaging procedure becomes complicated as compared with the local shutter method, and thus, it takes time to generate a frame. Therefore, the frame frequency decreases.

### [Distance Measurement Method]

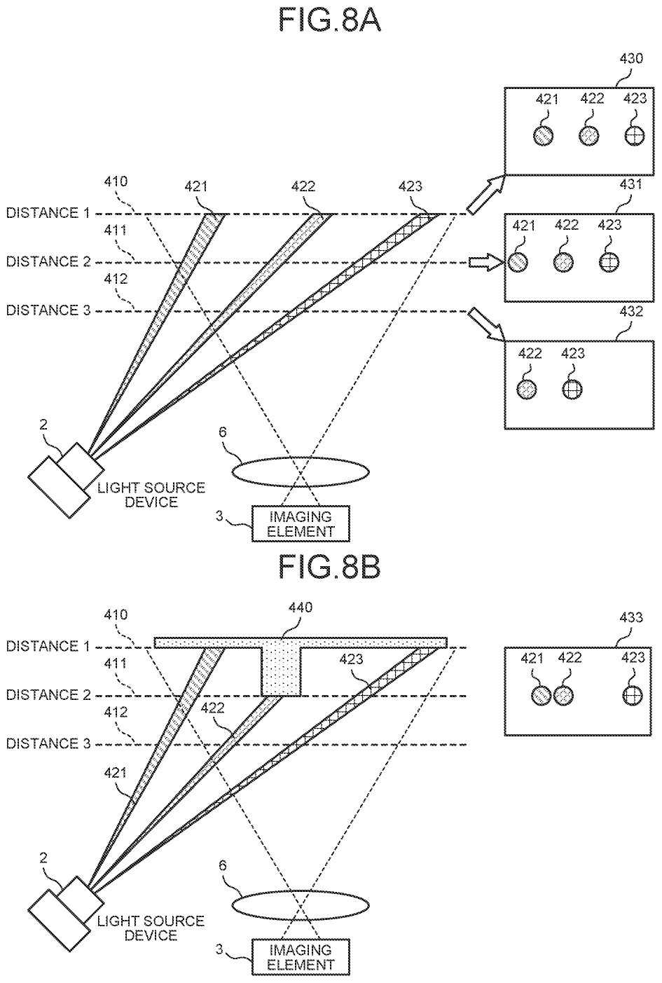

FIGS. 8A and 8B are diagrams illustrating an example of a distance measurement method according to the embodiment of the present disclosure. The drawing is a diagram illustrating a principle of the distance measurement method according to the present disclosure. In addition, the distance measurement method in the drawing is a distance measurement method based on the principle of triangulation.

The light source device 2 in the drawing emits pattern light in which a plurality of dotted bright portions are arranged. The pattern light in the drawing represents an example in which bright portions 421 to 423 are arranged. In addition, a “distance 1”, a “distance 2”, and a “distance 3” in the drawing respectively represent virtual surfaces irradiated with the pattern light from the light source device 2. The “distance 1”, the “distance 2”, and the “distance 3” are arranged in this order at positions away from the light source device 2 and the imaging element 3. The pattern light reflected from these surfaces is received by the imaging element 3 to form an image (a frame). It is noted that a lens 6 (not illustrated in FIG. 1) is illustrated in the drawing. The lens 6 is a lens that forms the image of the pattern light reflected by each surface on the imaging element 3.

FIG. 8A illustrates frames 430 to 431 when the pattern light reflected by surfaces of the “distance 1”, the “distance 2”, and the “distance 3” is imaged. In these frames 430 to 432, the bright portions 421 to 423 are arranged at positions corresponding to distances from the light source device 2. That is, the distance to the object can be measured based on the position of the bright portion 421 or the like arranged in the frame.

FIG. 8B illustrates an example of a case in which an object 440 having a convex portion at the central portion is arranged in the vicinity of the surface of the “distance 1”. When the pattern light reflected by the object 440 is imaged, a frame 433 in the drawing is obtained. In the frame 433, the bright portions 421 and 423 are disposed at positions corresponding to the “distance 1”, and the bright portion 422 is disposed at a position corresponding to the “distance 2”. A distance to the object 440 can be measured by the frame 433, and the surface shape of the object 440 can be acquired. Such a distance measurement method is referred to as a structured light method.

### [Information Processing Procedure]

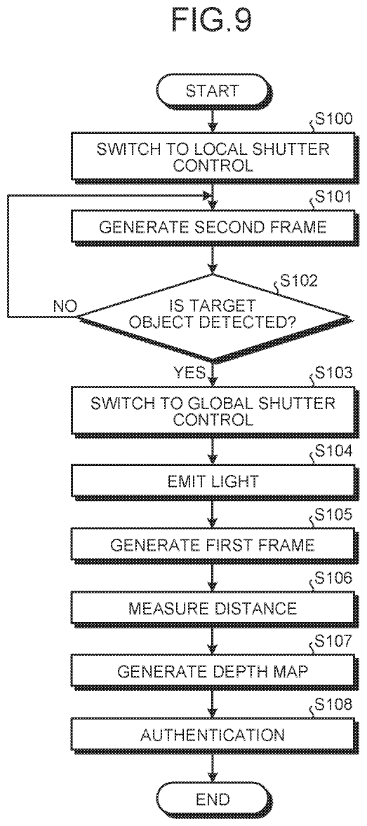

FIG. 9 is a diagram illustrating an example of a processing method according to the embodiment of the present disclosure. The drawing is a flowchart illustrating a procedure of processing in the information processing apparatus 1.

First, the control of the pixel 100 of the pixel array unit 11 is switched to the control of the local shutter (step S100). This can be performed by causing the pixel control unit 30 to switch to the control of the local shutter method. Next, a second frame is generated (step S101). This can be performed by allowing the image generation unit 40 to generate the second frame based on the second image signal generated by the pixel 100. Next, it is determined whether the object detection unit 50 detects a target object from the second frame (step S102). As a result, when the target object is not detected (step S102, No), the processing proceeds to processing in step S101. On the other hand, when the target object is detected (step S102, Yes), the processing proceeds to processing in step S103.

In step S103, the pixel 100 of the pixel array unit 11 is switched to the control of the global shutter (step S103). This can be performed by causing the pixel control unit 30 to switch to the control of the global shutter method. Next, light emission is started (step S104). This can be performed by allowing the light source device 2 to emit pattern light for distance measurement. Next, a first frame is generated (step S105). This can be performed by allowing the image generation unit 40 to generate the first frame based on the first image signal generated by the pixel 100.

Next, the distance measurement unit 60 measures a distance (step S106). Next, a depth map is generated (step S107). This can be performed by allowing the distance measurement unit 60 to generate the depth map of the target object based on the measured distance. Next, the authentication unit 80 authenticates the target object based on the depth map (step S108).

According to the above procedure, the information processing apparatus 1 can perform processing of detecting and authenticating the target object.

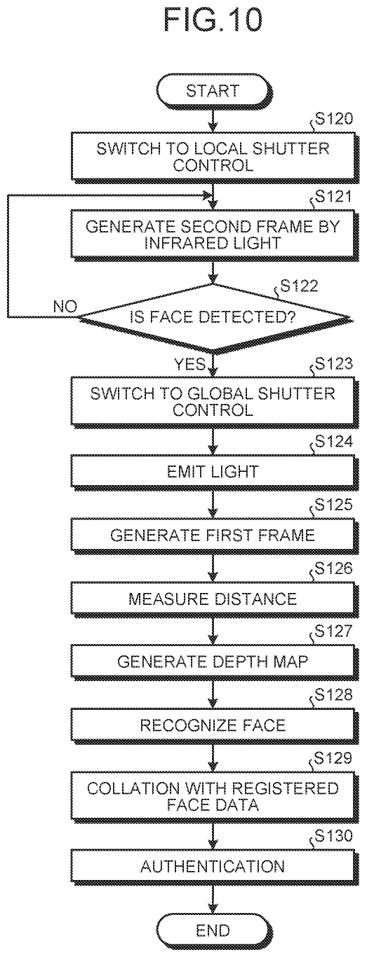

FIG. 10 is a diagram illustrating another example of the processing method according to the embodiment of the present disclosure. The drawing is a flowchart illustrating a procedure of processing in the information processing apparatus 1, and is a diagram illustrating a procedure of processing in a case where face authentication is performed. The information processing apparatus 1 that performs the processing in the drawing includes the imaging element 3 capable of imaging infrared light. It is noted that the information processing apparatus 1 that performs the processing in the drawing assumes a smartphone that performs face authentication.

First, the control of the pixel 100 of the pixel array unit 11 is switched to the control of the local shutter (step S120). Next, a second frame is generated by infrared light (step S121). Next, it is determined whether the object detection unit 50 detects a face as the target object (step S122). As a result, when no face is detected (step S122, No), the processing proceeds to processing in step S121. On the other hand, when the face is detected (step S122, Yes), the processing proceeds to processing in step S123.

In step S123, the pixel 100 of the pixel array unit 11 is switched to the control of the global shutter (step S123). Next, light emission by the pattern light is started (step S124). Next, a first frame is generated (step S125). Next, the distance measurement unit 60 measures a distance (step S126) and generates a depth map of the face (step S127). Next, the authentication unit 80 recognizes a face portion based on the depth map (step S128). Next, the authentication unit 80 collates face data with the registered face data (step S129) and authenticates the face data (step S130).

As described above, the information processing apparatus 1 according to the embodiment of the present disclosure can generate an image (a frame) based on the respective imaging methods using the imaging element 3 that performs imaging by switching between the local shutter method and the global shutter method. In addition, by applying the second frame generated by the local shutter method to the image for target object detection processing, the target object detection processing can be performed at high speed and power consumption can be reduced. In addition, the first frame with less distortion generated by the global shutter method is applied to acquire the three-dimensional shape of the target object for the authentication processing. As a result, a highly accurate three-dimensional shape can be acquired, and accuracy of the authentication processing can be improved. As described above, the information processing apparatus 1 can generate an image by performing switching between the local shutter method and the global shutter method according to the application.

### 2. Modification

The imaging element 3 of the above-described embodiment can also adopt other configurations. Another configuration example of the imaging element 3 will be described.

### [Configuration of Pixel]

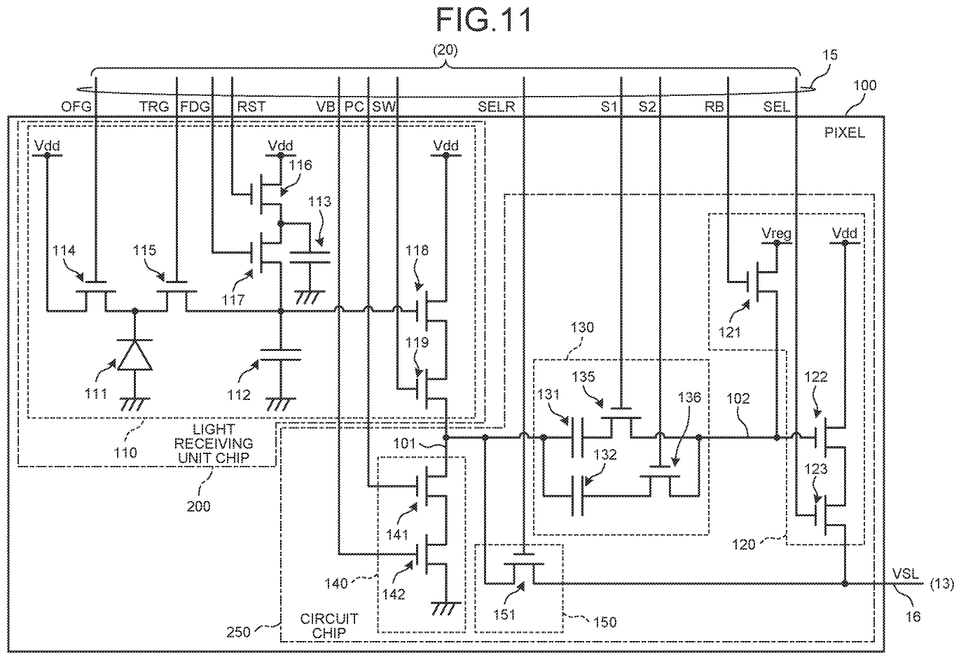

FIG. 11 is a diagram illustrating a configuration example of a pixel according to a modification of the embodiment of the present disclosure. The drawing is a circuit diagram illustrating a configuration example of the pixel 100, similarly to FIG. 3.

The light receiving unit 110 in the drawing further includes a charge discharging unit 114, a coupling unit 117, and a second charge storage unit 113. An n-channel MOS transistor can be applied to the charge discharging unit 114 and the coupling unit 117. The drain of the charge discharging unit 114 is connected to the power supply line Vdd, and the source thereof is connected to the cathode of the photoelectric conversion unit 111. The gate of the charge discharging unit 114 is connected to the signal OFG. The drain of the coupling unit 117 is connected to the source of the first reset unit 116, and the source thereof is connected to the drain of the charge transfer unit 115, the gate of the first amplification unit 118, and one end of the charge storage unit 112. The gate of the coupling unit 117 is connected to the signal line FDG. The second charge storage unit 113 is connected between the drain of the coupling unit 117 and the ground line.

The charge discharging unit 114 is a MOS transistor that resets the photoelectric conversion unit 111. The charge discharging unit 114 resets the photoelectric conversion unit 111 by discharging the charge of the photoelectric conversion unit 111 to the power supply line Vdd. By disposing the charge discharging unit 114, the photoelectric conversion unit 111 can be reset in a period during which the charge is stored in the charge storage unit 112, and the start of exposure in the next imaging can be advanced.

The second charge storage unit 113 stores a charge generated by photoelectric conversion in the photoelectric conversion unit 111. The second charge storage unit 113 stores a charge when coupled to the charge storage unit 112.

The coupling unit 117 couples the charge storage unit 112 to the second charge storage unit 113. The coupling unit 117 couples the second charge storage unit 113 to the charge storage unit 112 by connecting the second charge storage unit 113 to the charge storage unit 112 in parallel. By this coupling, it is possible to increase the retention capacity of the charge generated by the photoelectric conversion unit 111, and it is possible to adjust sensitivity.

The constant current circuit 140 in the drawing further includes a MOS transistor 142. The drain of the MOS transistor 142 is connected to the source of the MOS transistor 141, and the source thereof is grounded. The gate of the MOS transistor 142 is connected to the signal line VB.

Similarly to the signal line PC, a bias voltage is applied to the signal line VB. The MOS transistor 142 supplies a constant current corresponding to the bias voltage. By connecting the MOS transistors 141 and 142 in series and supplying the bias voltage to each gate, noise of the constant current circuit 140 can be reduced. In addition, it is possible to reduce fluctuation in output current when a power supply voltage fluctuates.

Furthermore, the pixel 100 in the drawing can be divided and arranged in a plurality of different semiconductor chips. This drawing illustrates an example of division into a light receiving unit chip 200 and a circuit chip 250. The light receiving unit 110 is arranged on the light receiving unit chip 200. In the circuit chip 250, the constant current circuit 140, the signal level storage unit 130, the first image signal generation unit 120, and the second image signal generation unit 150 are arranged. The light receiving unit chip 200 and the circuit chip 250 can be stacked. In this case, the area of the pixel 100 can be reduced.

Furthermore, a configuration in which the first image signal generation unit 120 and the second image signal generation unit 150 are shared by the plurality of pixels 100 can be adopted.

### [Another Configuration of Pixel]

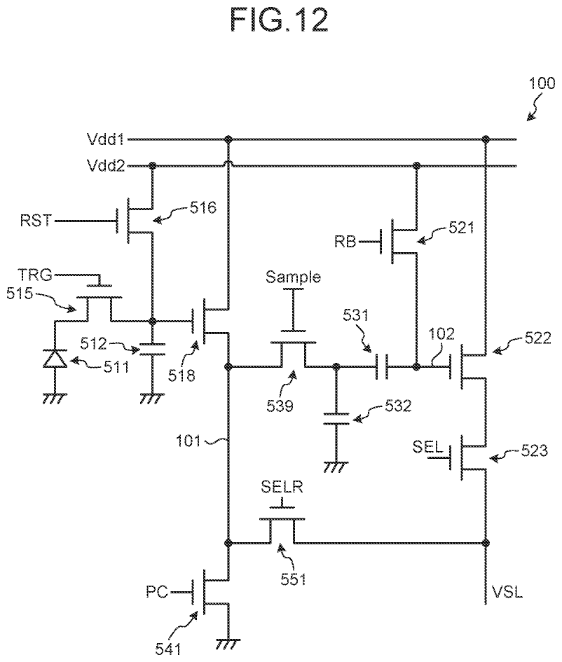

FIG. 12 is a diagram illustrating another configuration example of the pixel according to the modification of the embodiment of the present disclosure. The drawing is a circuit diagram illustrating a configuration example of the pixel 100, similarly to FIG. 11.

The pixel 100 in the drawing includes a photoelectric conversion unit 511, a charge storage unit 512, a charge transfer unit 515, a first reset unit 516, a first amplification unit 518, a MOS transistor 541, a second amplification unit 522, and a selection unit 523. Furthermore, the pixel 100 in the drawing further includes a sampling unit 539, a first capacitive element 531, a second capacitive element 532, and a MOS transistor 551.

The photoelectric conversion unit 511, the charge storage unit 512, the charge transfer unit 515, and the first reset unit 516 are similar to the photoelectric conversion unit 111, the charge storage unit 112, the charge transfer unit 115, the first reset unit 116, and the coupling unit 117 in FIG. 3, and thus a description thereof is omitted. In addition, the first amplification unit 518, the MOS transistor 541, the second reset unit 521, and the second amplification unit 522 are similar to the first amplification unit 118, the MOS transistor 141, the second reset unit 121, and the second amplification unit 122 in FIG. 3, and thus a description thereof will be omitted. Since the selection unit 523 is similar to the second selection unit 123 in FIG. 3, a description thereof will be omitted.

The sampling unit 539 opens and closes between the first capacitive element 531 and the second capacitive element 532, and the source of the first amplification unit 518. An n-channel MOS transistor can be applied to the sampling unit 539. The first capacitive element 531 is connected between the sampling unit 539 and the second amplification unit 522. The second capacitive element 532 is connected between the source of the sampling unit 539 and the ground line. Furthermore, the MOS transistor 551 is connected between the source of the first amplification unit 518 and the output signal line VSL. In the circuit of the drawing, a node connected to the source of the first amplification unit 518 corresponds to the first output node 101, and a node between the second capacitive element 532 and the gate of the second amplification unit 522 corresponds to the second output node 102.

In the pixel 100 in the drawing, circuits of the sampling unit 539, the first capacitive element 531, and the second capacitive element 532 constitute the signal level storage unit 130. When the first amplification unit 518 outputs the reset level to the first output node 101, the second reset unit 521 and the sampling unit 539 are conducted. As a result, the reset level is stored in the first capacitive element 531. Next, when the first amplification unit 518 outputs the signal level to the first output node 101, the sampling unit 539 is made conductive while the second reset unit 521 is brought into the non-conduction state. As a result, the signal level is stored in the second capacitive element 532. Thereafter, the sampling unit 539 is brought into the non-conduction state. As a result, a voltage in which the respective voltages of the second capacitive element 532 and the first capacitive element 531 are superimposed is applied to the second output node 102. This voltage corresponds to a voltage obtained by subtracting the reset level from the signal level. The second amplification unit 522 and the selection unit 523 constituting the first image signal generation unit 120 generate the first image signal according to the voltage of the second output node 102.

The MOS transistor 551 in the drawing constitutes the second image signal generation unit 150. The MOS transistor 551 outputs the voltage level of the first output node 101 to the signal line VSL as a second image signal.

In the pixel 100 in the drawing as well, the signal level storage unit 130 and the first image signal generation unit 120 can be used at the time of imaging of the global shutter method. Furthermore, the second image signal generation unit 150 can be used at the time of imaging by the local shutter method.

### Effects

The information processing apparatus 1 according to the present disclosure includes the pixel 100 array unit 11, the pixel control unit 30, the image generation unit 40, the object detection unit 50, the distance measurement unit, and the control unit 70. In the pixel 100 array unit 11, the pixels 100 are arranged in a two-dimensional matrix, in which each of the pixels 100 includes a light receiving unit that exposes incident light and outputs a voltage level corresponding to an exposure amount, a signal level storage unit that stores the voltage level output from the light receiving unit, a first image signal generation unit that generates a first image signal, which is a signal corresponding to the voltage level stored in the signal level storage unit, and the second image signal generation unit that generates a second image signal, which is a signal corresponding to the voltage level output from the light receiving unit. The pixel control unit 30 performs a local shutter that sequentially performs, on the pixels 100, exposure of the incident light in the light receiving unit and generation of the second image signal in the second image signal generation unit based on the voltage level output after the exposure at a timing shifted for each row of the pixel 100 array unit 11, and a global shutter that simultaneously performs, on the pixels 100 arranged in the pixel 100 array unit 11, the exposure of the incident light in the light receiving unit and storage of the voltage level output after the exposure in the signal level storage unit and sequentially performs generation of the first image signal in the first image signal generation unit at a timing shifted for each row of the pixel 100 array unit 11. The image generation unit 40 generates a first frame, which is an image based on the first image signal, and a second frame, which is an image based on the second image signal. The object detection unit 50 detects a target object from the second frame. The distance measurement unit 60 measures a distance to the target object based on the first frame generated based on reflected light obtained by allowing the emitted light emitted to the target object to be reflected by the target object. The control unit 70 performs second frame generation control of causing the pixel control unit 30 to control a local shutter and causing the image generation unit 40 to generate the second frame, target object detection control of causing the object detection unit 50 to detect the target object, first frame generation control of causing the pixel control unit 30 to control a global shutter and causing the image generation unit 40 to generate the first frame, and distance measurement control of causing the distance measurement unit 60 to measure the distance to the target object. As a result, it is possible to perform switching between imaging of the local shutter method and imaging of the global shutter method in the pixel 100 according to an application.

The light receiving unit may include a photoelectric conversion unit configured to perform photoelectric conversion of the incident light, a charge storage unit configured to store a charge generated by the photoelectric conversion, a charge transfer unit configured to transfer, to the charge storage unit, the charge generated by the photoelectric conversion during an exposure period, an amplification unit configured to output a voltage level corresponding to the charge stored in the charge storage unit, and a reset unit configured to reset the charge storage unit.

The light receiving unit may output a signal level, which is the voltage level when the charge generated during the exposure period is stored in the charge storage unit, and a reset level, which is the voltage level after being reset by the reset unit, the signal level storage unit may store each of the output signal level and the output reset level, the first image signal generation unit may generate the first image signal corresponding to the stored signal level and the stored reset level, and the second image signal generation unit may generate the second image signal corresponding to the output signal level and the output reset level. As a result, the reset level can be extracted as an offset.

The information processing apparatus may further include an image signal processing unit configured to perform processing of subtracting the first image signal corresponding to the reset level from the first image signal corresponding to the signal level and processing of subtracting the second image signal corresponding to the reset level from the second image signal corresponding to the signal level, in which the image generation unit 40 may generate the first frame based on the first image signal processed by the image signal processing unit, and may generate the second frame based on the second image signal processed by the image signal processing unit. As a result, an offset error of the signal level can be deleted.

The light source device 2 that emits the emitted light to the target object may be further included, and the control unit 70 may further perform light source control of causing the light source device 2 to emit the emitted light.

The light source device 2 may emit pattern light having a bright portion and a dark portion, and the distance measurement unit 60 may measure the distance to the target object based on the pattern light of the reflected light.

The authentication unit 80 configured to perform authentication of the target object based on the distance measured by the distance measurement unit 60 may be further included.

The distance measurement unit 60 may generate a depth map of the target object based on the measured distance, and the authentication unit 80 may perform the authentication based on the generated depth map.

The object detection unit 50 may detect a face as the target object, the distance measurement unit 60 may generate the depth map of the face, and the authentication unit 80 may recognize the face and perform the authentication.

It is noted that the effects described in the present specification are merely examples and are not limited, and other effects may be obtained.

It is noted that the present technology can also have the following configurations.

(1)

An information processing apparatus comprising:
a pixel array unit having pixels arranged therein in a two-dimensional matrix, the pixel including a light receiving unit configured to expose incident light and to output a voltage level corresponding to an exposure amount, a signal level storage unit configured to store the voltage level output from the light receiving unit, a first image signal generation unit configured to generate a first image signal, which is a signal corresponding to the voltage level stored in the signal level storage unit, and a second image signal generation unit configured to generate a second image signal, which is a signal corresponding to the voltage level output from the light receiving unit;
a pixel control unit configured to perform a local shutter and a global shutter, wherein the local shutter sequentially performs, on the pixels, exposure of the incident light in the light receiving unit and generation of the second image signal in the second image signal generation unit based on the voltage level output after the exposure at a timing shifted for each row of the pixel array unit, and the global shutter simultaneously performs, on the pixels arranged in the pixel array unit, the exposure of the incident light in the light receiving unit and storage of the voltage level output after the exposure in the signal level storage unit, and sequentially performs generation of the first image signal in the first image signal generation unit at the timing shifted for each row of the pixel array unit;
an image generation unit configured to generate a first frame, which is an image based on the first image signal, and a second frame, which is an image based on the second image signal;
an object detection unit configured to detect a target object from the second frame;
a distance measurement unit configured to measure a distance to the target object based on the first frame generated based on reflected light obtained by allowing emitted light emitted to the target object to be reflected by the target object; and
a control unit configured to perform second frame generation control of causing the pixel control unit to control the local shutter and causing the image generation unit to generate the second frame, target object detection control of causing the object detection unit to detect the target object, first frame generation control of causing the pixel control unit to control the global shutter and causing the image generation unit to generate the first frame, and distance measurement control of causing the distance measurement unit to measure the distance to the target object.
   (2)

The information processing apparatus according to the above (1), wherein the light receiving unit includes a photoelectric conversion unit configured to perform photoelectric conversion of the incident light, a charge storage unit configured to store a charge generated by the photoelectric conversion, a charge transfer unit configured to transfer, to the charge storage unit, the charge generated by the photoelectric conversion during an exposure period, an amplification unit configured to output a voltage level corresponding to the charge stored in the charge storage unit, and a reset unit configured to reset the charge storage unit.

(3)

The information processing apparatus according to the above (2), wherein
the light receiving unit is configured to output a signal level, which is the voltage level when the charge generated during the exposure period is stored in the charge storage unit, and a reset level, which is the voltage level after being reset by the reset unit,
the signal level storage unit is configured to store each of the output signal level and the output reset level,
the first image signal generation unit is configured to generate the first image signal corresponding to the stored signal level and the stored reset level, and
the second image signal generation unit is configured to generate the second image signal corresponding to the output signal level and the output reset level.
   (4)

The information processing apparatus according to the above (3), further comprising an image signal processing unit configured to perform processing of subtracting the first image signal corresponding to the reset level from the first image signal corresponding to the signal level and processing of subtracting the second image signal corresponding to the reset level from the second image signal corresponding to the signal level, wherein
the image generation unit is configured to generate the first frame based on the first image signal processed by the image signal processing unit and to generate the second frame based on the second image signal processed by the image signal processing unit.
   (5)

The information processing apparatus according to any one of the above (1) to (4), further comprising a light source unit configured to emit the emitted light to the target object, wherein
the control unit is configured to further perform light source control of causing the light source unit to emit the emitted light.
   (6)

The information processing apparatus according to the above (5), wherein
the light source unit is configured to emit pattern light having a bright portion and a dark portion, and
the distance measurement unit is configured to measure the distance to the target object based on the pattern light of the reflected light.
   (7)

The information processing apparatus according to any one of the above (1) to (6), further comprising an authentication unit configured to perform authentication of the target object based on the distance measured by the distance measurement unit.

(8)

The information processing apparatus according to the above (7), wherein
the distance measurement unit is configured to generate a depth map of the target object based on the measured distance, and
the authentication unit is configured to perform the authentication based on the generated depth map.
   (9)

The information processing apparatus according to the above (8), wherein
the object detection unit is configured to detect a face as the target object,
the distance measurement unit is configured to generate the depth map of the face, and
the authentication unit is configured to recognize the face so as to perform the authentication.
   (10)

An information processing system comprising:
a pixel array unit having pixels arranged therein in a two-dimensional matrix, the pixel including a light receiving unit configured to expose incident light and to output a voltage level corresponding to an exposure amount, a signal level storage unit configured to store the voltage level output from the light receiving unit, a first image signal generation unit configured to generate a first image signal, which is a signal corresponding to the voltage level stored in the signal level storage unit, and a second image signal generation unit configured to generate a second image signal, which is a signal corresponding to the voltage level output from the light receiving unit;
a pixel control unit configured to perform a local shutter and a global shutter, wherein the local shutter sequentially performs, on the pixels, exposure of the incident light in the light receiving unit and generation of the second image signal in the second image signal generation unit based on the voltage level output after the exposure at a timing shifted for each row of the pixel array unit, and the global shutter simultaneously performs, on the pixels arranged in the pixel array unit, the exposure of the incident light in the light receiving unit and storage of the voltage level output after the exposure in the signal level storage unit, and sequentially performs generation of the first image signal in the first image signal generation unit at the timing shifted for each row of the pixel array unit;
an image generation unit configured to generate a first frame, which is an image based on the first image signal, and a second frame, which is an image based on the second image signal;
an object detection unit configured to detect a target object from the second frame;
a distance measurement unit configured to measure a distance to the target object based on the first frame generated based on reflected light obtained by allowing emitted light emitted to the target object to be reflected by the target object; and
a control unit configured to perform second frame generation control of causing the pixel control unit to control the local shutter and causing the image generation unit to generate the second frame, target object detection control of causing the object detection unit to detect the target object, first frame generation control of causing the pixel control unit to control the global shutter and causing the image generation unit to generate the first frame, and distance measurement control of causing the distance measurement unit to measure the distance to the target object.
   (11)

The information processing system according to the above (10), wherein the light receiving unit includes a photoelectric conversion unit configured to perform photoelectric conversion of the incident light, a charge storage unit configured to store a charge generated by the photoelectric conversion, a charge transfer unit configured to transfer, to the charge storage unit, the charge generated by the photoelectric conversion during an exposure period, an amplification unit configured to output a voltage level corresponding to the charge stored in the charge storage unit, and a reset unit configured to reset the charge storage unit.

(12)

The information processing system according to the above (11), wherein
the light receiving unit is configured to output a signal level, which is the voltage level when the charge generated during the exposure period is stored in the charge storage unit, and a reset level, which is the voltage level after being reset by the reset unit,
the signal level storage unit is configured to store each of the output signal level and the output reset level,
the first image signal generation unit is configured to generate the first image signal corresponding to the stored signal level and the stored reset level, and
the second image signal generation unit is configured to generate the second image signal corresponding to the output signal level and the output reset level.
   (13)

The information processing system according to the above (12), further comprising an image signal processing unit configured to perform processing of subtracting the first image signal corresponding to the reset level from the first image signal corresponding to the signal level and processing of subtracting the second image signal corresponding to the reset level from the second image signal corresponding to the signal level, wherein
the image generation unit is configured to generate the first frame based on the first image signal processed by the image signal processing unit and to generate the second frame based on the second image signal processed by the image signal processing unit.
   (14)

The information processing system according to any one of the above (10) to (13), further comprising a light source unit configured to emit the emitted light to the target object, wherein
the control unit is configured to further perform light source control of causing the light source unit to emit the emitted light.
   (15)

The information processing system according to the above (14), wherein
the light source unit is configured to emit pattern light having a bright portion and a dark portion, and
the distance measurement unit is configured to measure the distance to the target object based on the pattern light of the reflected light.
   (16)

The information processing system according to any one of the above (10) to (15), further comprising an authentication unit configured to perform authentication of the target object based on the distance measured by the distance measurement unit.

(17)

The information processing system according to the above (16), wherein
the distance measurement unit is configured to generate a depth map of the target object based on the measured distance, and
the authentication unit is configured to perform the authentication based on the generated depth map.
   (18)

The information processing system according to the above (17), wherein
the object detection unit is configured to detect a face as the target object,
the distance measurement unit is configured to generate the depth map of the face, and
the authentication unit is configured to recognize the face so as to perform the authentication.

### REFERENCE SIGNS LIST

1 INFORMATION PROCESSING APPARATUS
2 LIGHT SOURCE DEVICE
3 IMAGING ELEMENT
11 PIXEL ARRAY UNIT
12 VERTICAL DRIVE UNIT
13 COLUMN SIGNAL PROCESSING UNIT
30 PIXEL CONTROL UNIT
40 IMAGE GENERATION UNIT
50 OBJECT DETECTION UNIT
60 DISTANCE MEASUREMENT UNIT
70 CONTROL UNIT
80 AUTHENTICATION UNIT
100 PIXEL
110 LIGHT RECEIVING UNIT
111, 511 PHOTOELECTRIC CONVERSION UNIT
112, 512 CHARGE STORAGE UNIT
114 CHARGE DISCHARGING UNIT
115, 515 CHARGE TRANSFER UNIT
116, 516 FIRST RESET UNIT
118, 518 FIRST AMPLIFICATION UNIT
119 FIRST SELECTION UNIT
120 FIRST IMAGE SIGNAL GENERATION UNIT
121, 521 SECOND RESET UNIT
122, 522 SECOND AMPLIFICATION UNIT
123 SECOND SELECTION UNIT
130 SIGNAL LEVEL STORAGE UNIT
131, 531 FIRST CAPACITIVE ELEMENT
132, 532 SECOND CAPACITIVE ELEMENT
135 FIRST SWITCH ELEMENT
136 SECOND SWITCH ELEMENT
150 SECOND IMAGE SIGNAL GENERATION UNIT
151, 551 MOS TRANSISTOR
523 SELECTION UNIT
539 SAMPLING UNIT

1. An information processing apparatus comprising:
a pixel array unit having pixels arranged therein in a two-dimensional matrix, the pixel including a light receiving unit configured to expose incident light and to output a voltage level corresponding to an exposure amount, a signal level storage unit configured to store the voltage level output from the light receiving unit, a first image signal generation unit configured to generate a first image signal, which is a signal corresponding to the voltage level stored in the signal level storage unit, and a second image signal generation unit configured to generate a second image signal, which is a signal corresponding to the voltage level output from the light receiving unit;
a pixel control unit configured to perform a local shutter and a global shutter, wherein the local shutter sequentially performs, on the pixels, exposure of the incident light in the light receiving unit and generation of the second image signal in the second image signal generation unit based on the voltage level output after the exposure at a timing shifted for each row of the pixel array unit, and the global shutter simultaneously performs, on the pixels arranged in the pixel array unit, the exposure of the incident light in the light receiving unit and storage of the voltage level output after the exposure in the signal level storage unit, and sequentially performs generation of the first image signal in the first image signal generation unit at the timing shifted for each row of the pixel array unit;
an image generation unit configured to generate a first frame, which is an image based on the first image signal, and a second frame, which is an image based on the second image signal;
an object detection unit configured to detect a target object from the second frame;
a distance measurement unit configured to measure a distance to the target object based on the first frame generated based on reflected light obtained by allowing emitted light emitted to the target object to be reflected by the target object; and
a control unit configured to perform second frame generation control of causing the pixel control unit to control the local shutter and causing the image generation unit to generate the second frame, target object detection control of causing the object detection unit to detect the target object, first frame generation control of causing the pixel control unit to control the global shutter and causing the image generation unit to generate the first frame, and distance measurement control of causing the distance measurement unit to measure the distance to the target object.

2. The information processing apparatus according to claim 1, wherein the light receiving unit includes a photoelectric conversion unit configured to perform photoelectric conversion of the incident light, a charge storage unit configured to store a charge generated by the photoelectric conversion, a charge transfer unit configured to transfer, to the charge storage unit, the charge generated by the photoelectric conversion during an exposure period, an amplification unit configured to output a voltage level corresponding to the charge stored in the charge storage unit, and a reset unit configured to reset the charge storage unit.

3. The information processing apparatus according to claim 2, wherein
the light receiving unit is configured to output a signal level, which is the voltage level when the charge generated during the exposure period is stored in the charge storage unit, and a reset level, which is the voltage level after being reset by the reset unit,
the signal level storage unit is configured to store each of the output signal level and the output reset level,
the first image signal generation unit is configured to generate the first image signal corresponding to the stored signal level and the stored reset level, and
the second image signal generation unit is configured to generate the second image signal corresponding to the output signal level and the output reset level.

4. The information processing apparatus according to claim 3, further comprising an image signal processing unit configured to perform processing of subtracting the first image signal corresponding to the reset level from the first image signal corresponding to the signal level and processing of subtracting the second image signal corresponding to the reset level from the second image signal corresponding to the signal level, wherein
the image generation unit is configured to generate the first frame based on the first image signal processed by the image signal processing unit and to generate the second frame based on the second image signal processed by the image signal processing unit.

5. The information processing apparatus according to claim 1, further comprising a light source unit configured to emit the emitted light to the target object, wherein
the control unit is configured to further perform light source control of causing the light source unit to emit the emitted light.

6. The information processing apparatus according to claim 5, wherein
the light source unit is configured to emit pattern light having a bright portion and a dark portion, and
the distance measurement unit is configured to measure the distance to the target object based on the pattern light of the reflected light.

7. The information processing apparatus according to claim 1, further comprising an authentication unit configured to perform authentication of the target object based on the distance measured by the distance measurement unit.

8. The information processing apparatus according to claim 7, wherein
the distance measurement unit is configured to generate a depth map of the target object based on the measured distance, and
the authentication unit is configured to perform the authentication based on the generated depth map.

9. The information processing apparatus according to claim 8, wherein
the object detection unit is configured to detect a face as the target object,
the distance measurement unit is configured to generate the depth map of the face, and
the authentication unit is configured to recognize the face so as to perform the authentication.

10. An information processing system comprising:
a pixel array unit having pixels arranged therein in a two-dimensional matrix, the pixel including a light receiving unit configured to expose incident light and to output a voltage level corresponding to an exposure amount, a signal level storage unit configured to store the voltage level output from the light receiving unit, a first image signal generation unit configured to generate a first image signal, which is a signal corresponding to the voltage level stored in the signal level storage unit, and a second image signal generation unit configured to generate a second image signal, which is a signal corresponding to the voltage level output from the light receiving unit;
a pixel control unit configured to perform a local shutter and a global shutter, wherein the local shutter sequentially performs, on the pixels, exposure of the incident light in the light receiving unit and generation of the second image signal in the second image signal generation unit based on the voltage level output after the exposure at a timing shifted for each row of the pixel array unit, and the global shutter simultaneously performs, on the pixels arranged in the pixel array unit, the exposure of the incident light in the light receiving unit and storage of the voltage level output after the exposure in the signal level storage unit, and sequentially performs generation of the first image signal in the first image signal generation unit at the timing shifted for each row of the pixel array unit;
an image generation unit configured to generate a first frame, which is an image based on the first image signal, and a second frame, which is an image based on the second image signal;
an object detection unit configured to detect a target object from the second frame;
a distance measurement unit configured to measure a distance to the target object based on the first frame generated based on reflected light obtained by allowing emitted light emitted to the target object to be reflected by the target object; and
a control unit configured to perform second frame generation control of causing the pixel control unit to control the local shutter and causing the image generation unit to generate the second frame, target object detection control of causing the object detection unit to detect the target object, first frame generation control of causing the pixel control unit to control the global shutter and causing the image generation unit to generate the first frame, and distance measurement control of causing the distance measurement unit to measure the distance to the target object.

11. The information processing system according to claim 10, wherein the light receiving unit includes a photoelectric conversion unit configured to perform photoelectric conversion of the incident light, a charge storage unit configured to store a charge generated by the photoelectric conversion, a charge transfer unit configured to transfer, to the charge storage unit, the charge generated by the photoelectric conversion during an exposure period, an amplification unit configured to output a voltage level corresponding to the charge stored in the charge storage unit, and a reset unit configured to reset the charge storage unit.

12. The information processing system according to claim 11, wherein
the light receiving unit is configured to output a signal level, which is the voltage level when the charge generated during the exposure period is stored in the charge storage unit, and a reset level, which is the voltage level after being reset by the reset unit,
the signal level storage unit is configured to store each of the output signal level and the output reset level,
the first image signal generation unit is configured to generate the first image signal corresponding to the stored signal level and the stored reset level, and
the second image signal generation unit is configured to generate the second image signal corresponding to the output signal level and the output reset level.

13. The information processing system according to claim 12, further comprising an image signal processing unit configured to perform processing of subtracting the first image signal corresponding to the reset level from the first image signal corresponding to the signal level and processing of subtracting the second image signal corresponding to the reset level from the second image signal corresponding to the signal level, wherein
the image generation unit is configured to generate the first frame based on the first image signal processed by the image signal processing unit and to generate the second frame based on the second image signal processed by the image signal processing unit.

14. The information processing system according to claim 10, further comprising a light source unit configured to emit the emitted light to the target object, wherein
the control unit is configured to further perform light source control of causing the light source unit to emit the emitted light.

15. The information processing system according to claim 14, wherein
the light source unit is configured to emit pattern light having a bright portion and a dark portion, and
the distance measurement unit is configured to measure the distance to the target object based on the pattern light of the reflected light.

16. The information processing system according to claim 10, further comprising an authentication unit configured to perform authentication of the target object based on the distance measured by the distance measurement unit.

17. The information processing system according to claim 16, wherein
the distance measurement unit is configured to generate a depth map of the target object based on the measured distance, and
the authentication unit is configured to perform the authentication based on the generated depth map.

18. The information processing system according to claim 17, wherein
the object detection unit is configured to detect a face as the target object,
the distance measurement unit is configured to generate the depth map of the face, and
the authentication unit is configured to recognize the face so as to perform the authentication.
